(19) United States
(12) Patent Application Publication
(10) Pub. No.: US 2006/0113888 A1
(43) Pub. Date: Jun. 1, 2006

(54) Field emission display device with protection structure

(76) Inventors: Huai-Yuan Tseng, Tao-Yuan (TW); Chun-Yao Huang, Hsin-Chu (TW); Yu-Wu Wang, Hsin-Chu (TW); Yung-Hui Yeh, Hsin-Chu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 10/999,987

(22) Filed: Dec. 1, 2004

(51) Int. Cl. H01J 63/04; H01J 1/62

(52) U.S. Cl. 313/495

(57) ABSTRACT

A novel protection structure for protecting field emission elements in a field emission display device from burnout damage due to electrical current surges induced to the device cathode by ionized gases in the device. The protection structure includes one or multiple reduction plates or electrodes which are typically provided on the cathode. The reduction plate or plates are negatively-charged and attract positively charged gas ions. Consequently, induction of electrical current surges to the cathode is avoided, thereby preventing burnout damage to the field emission elements.

### BACKGROUND

1. Field of the Invention

The present invention generally relates to field emission display panels or devices, and more particularly, relates to a field emission display device having at least one reduction plate or electrode which deflects ionic emission gas away from the field emission components of the device to prevent damage to the field emission components.

2. Background of the Invention

In recent years, flat panel display devices have been developed and used in electronic applications such as personal computers. One of the popularly-used flat panel display devices is an active matrix liquid crystal display which provides improved resolution. However, liquid crystal display devices have many inherent limitations that render them unsuitable for a number of applications. For instance, liquid crystal displays have numerous fabrication limitations including a slow deposition process for coating a glass panel with amorphous silicon, high manufacturing complexity and low yield. Moreover, the liquid crystal display devices require a fluorescent back light which draws high power while most of the light generated is wasted. A liquid crystal display image may be difficult to see under bright light conditions or at wide viewing angles which further limit its use in many applications.

Other flat panel display devices have been developed in recent years to replace the liquid crystal display panels. One of such devices is a field emission display device that overcomes some of the limitations of LCD and provides significant advantages over the traditional LCD devices. For instance, the field emission display devices have higher contrast ratio, larger viewing angle, higher maximum brightness, lower power consumption and a wider operating temperature range when compared to conventional thin film transistor (TFT) liquid crystal display panels.

A most drastic difference between an FED and an LCD is that, unlike the LCD, the FED utilizes colored phosphors to produce its own light. The FEDs do not require complicated, power-consuming back lights and filters and, as a result, almost all the light generated by an FED is visible to the user. Moreover, the FEDs do not require large arrays of thin film transistors, and thus, a major source of high cost and yield problems for active matrix LCDs is eliminated.

In an FED, electrons are emitted from a cathode and impinge on phosphors coated on the back of a transparent cover plate to produce an image. Such a cathodoluminescent process is known as one of the most efficient methods for generating light. In contrast to a conventional CRT device, each pixel or emission unit in an FED has its own electron source, i.e., typically an array of emitting microtips. A voltage difference exists between a cathode and a gate electrode which extracts electrons from the cathode and accelerates them toward the phosphor coating. The emission current, and thus, the display brightness, is strongly dependent on the work function of the emitting material. To achieve the necessary efficiency of an FED, the cleanliness and uniformity of the emitter source material are very important.

In order for electrons to travel in an FED, most FEDs are evacuated to a low pressure such as 10⁻⁷ torr in order to provide a log mean free path for the emitted electrons and to prevent contamination and deterioration of the microtips. The resolution of the display can be improved by using a focus grid to collimate electrons drawn from the microtips.

In the early development for field emission cathodes, a metal microtip emitter of molybdenum was utilized. In such a device, a silicon wafer is first oxidized to produce a thick silicon oxide layer and then a metallic gate layer is deposited on top of the oxide. The metallic gate layer is then patterned to form gate openings, while subsequent etching of the silicon oxide underneath the openings undercuts the gate and creates a well. A sacrificial material layer such as nickel is deposited to prevent deposition of nickel into the emitter wall. Molybdenum is then deposited at normal incidence such that a cone with a sharp point grows inside the cavity until the opening closes there above. An emitter cone is left when the sacrificial layer of nickel is removed.

In an alternative design, silicon microtip emitters are produced by first conducting a thermal oxidation on silicon, followed by patterning the oxide and selectively etching to form silicon tips. Further oxidation or etching protects the silicon and sharpens the point to provide a sacrificial layer. In another alternate design, the microtips are built onto a substrate of a desirable material such as glass, as an ideal substrate for large area flat panel displays. The microtips can be formed of conducting materials such as metals or doped semi-conducting materials. In this alternate design for a FED device, an interlayer that has controlled conductivity deposited between the cathode and the microtips is highly desirable. A proper resistivity of the interlayer enables the device to operate in a stable condition. In fabricating such FED devices, it is therefore desirable to deposit an amorphous silicon film which has electrical conductivity in an intermediate range between that of intrinsic amorphous silicon and n⁺ doped amorphous silicon. The conductivity of the n⁺ doped amorphous silicon can be controlled by adjusting the amount of phosphorous atoms contained in the film.

Generally, in the fabrication of an FED device, the device is contained in a cavity of very low pressure such that the emission of electrons is not impeded. For instance, a low pressure of 10⁻⁷ torr is normally required. In order to prevent the collapse of two relatively large glass panels which form the FED device, spacers must be used to support and provide proper spacing between the two panels. For instance, in conventional FED devices, glass spheres or glass crosses have been used for maintaining such spacings in FED devices. Elongated spacers have also been used for such purposes.

FIG. 1A shows an enlarged cross-sectional view of a conventional field emission display device 10. The FED device 10 is formed by depositing a resistive layer 12 of typically an amorphous silicon base film on a glass substrate 14. An insulating layer 16 of a dielectric material and a metallic gate layer 18 are then deposited and formed together to provide metallic microtips 20 and a cathode structure 22 is covered by the resistive layer 12 and thus, a resistive but somewhat conductive amorphous silicon layer 12 underlies a highly insulating layer 16 which is formed of a dielectric material such as SiO₂. It is important to be able to control the resistivity of the amorphous silicon layer 12 such that it is not overly resistive but yet, it will act as a limiting resistor to prevent excessive current flow if one of the microtips 20 shorts to the metal layer 18.

A completed FED structure 30, including an anode 28 mounted on top of the structure 30, is shown in FIG. 1B. It is to be noted, for simplicity, that the cathode layer 22 and the resistive layer 12 are shown as a single layer 22 for the cathode. The microtips 20 are formed to emit electrons 26 from the tips of the microtips 20. The gate electrodes 18 are provided with a positive charge, while the anode 28 is provided with a higher positive charge. The anode 28 is formed by a glass plate 36 which is coated with phosphorous particles 32. An intermittent conductive indium-tin-oxide (ITO) layer 34 may also be utilized to further improve the brightness of the phosphorous layer when bombarded by the electrons 26. This is shown in a partial, enlarged cross-sectional view of FIG. 1C. The total thickness of the FED device is only about 2 mm, with vacuum pulled in-between the lower glass plate 14 and the upper glass plate 36 sealed by sidewall panels 38 (shown in FIG. 1B).

The conventional FED devices formed with microtips shown in FIGS. 1A-1C produce a flat panel display device of improved quality when compared to liquid crystal display devices. However, a major disadvantage of the microtip FED device is the complicated processing steps that must be used to fabricate the device. For instance, the formation of the various layers in the device, and specifically, the formation of the microtips, requires a thin film deposition technique that utilizes a photolithographic method. As a result, numerous photomasking steps must be performed in order to define and fabricate the various structural features in the FED. The CVD deposition processes and the photolithographic processes involved greatly increase the manufacturing cost of an FED device.

In a co-pending application Ser. No. 09/377,315, filed Aug. 19, 1999, assigned to the common assignee of the present invention, a field emission display device and a method for fabricating such device of a triode structure using nanotube emitters as the electron emission sources were disclosed. In the triode structure FED device, the device is constructed by a first electrically insulating plate, a cathode formed on the first electrically insulating plate by a material that includes metal, a layer formed on the cathode of a high electrical resistivity material, a layer of nanotube emitters formed on the resistivity layer of a material of carbon, diamond or diamond-like carbon wherein the cathode, the resistivity layer and the nanotube emitter layer form an emitter stack insulated by an insulating rib section from adjacent emitter stacks, a dielectric material layer perpendicularly overlying a multiplicity of the emitter stacks, a gate electrode on top of the dielectric material layer, and an anode formed on a second electrically insulating plate overlying the gate electrode. The FED device proposed can be fabricated advantageously by a thick film printing technique at substantially lower fabrication cost and higher fabrication efficiency than the FEDs utilizing microtips.

In another co-pending application Ser. No. 09/396,536, filed Sep. 15, 1999, assigned to the common assignee of the present invention, a field effect emission display device and a method for fabricating the diode structure device using nanotube emitters as the electron emission sources were disclosed. In the diode structure FED device, the device is constructed by a first glass plate that has a plurality of emitter stacks formed on a top surface. Each of the emitter stacks is formed parallel to a transverse direction of the glass plate and includes a layer of electrically conductive material such as silver paste and a layer of nanotube emitter on top. The first glass plate has a plurality of rib sections formed of an insulating material in-between the plurality of emitter stacks to provide electrical insulation. A second glass plate is positioned over and spaced-apart from the first glass plate with an inside surface coated with a layer of an electrically conductive material such as indium-tin-oxide. A multiplicity of fluorescent powder coating strips is then formed on the ITO layer each for emitting a red, green or blue light when activated by electrons emitted from the plurality of emitter stacks. The field emission display panel is assembled together by a number of side panels that join the peripheries of the first and second glass plate together to form a vacuum-tight cavity therein.

FIGS. 2A and 2B show a schematic view of a conventional FED device 40. The FED device 40 includes a cathode 42 which is spaced from an anode 46. Multiple field emission elements 44 are provided in electrical contact with the cathode 42 for emitting electrons 52 toward the anode 46. A voltage source 48 is provided to apply a voltage potential which establishes an electric field 50 between the cathode 42 and the anode 46.

During operation of the FED device 40, oxygen and nitrogen are typically present at low pressures between the cathode 42 and the anode 46. When the FED device 40 is energized, a voltage potential is applied by the voltage source 48, between the cathode 42 and the anode 46, to establish the electric field 50. High-energy electrons 52 are emitted from the field emission elements 44, toward the anode 46. These high-energy electrons 52 strike the nitrogen and oxygen gas and form positive nitrogen and oxygen ions, as shown in FIG. 2B. The nitrogen and oxygen ions discharge to the cathode 42, causing a surge of the electrical current passing to the cathode 42 and field emission elements 44. This magnified electrical current tends to burn and damage the field emission elements 44. Accordingly, a protection structure is needed for deflecting a discharge path of ionized gases away from a cathode in an FED device to prevent electrical surging and burn-out damage to field emission elements in the device.

### BRIEF SUMMARY OF THE INVENTION

An object of the present invention is to provide a novel protection structure for preventing burn-out damage to field emission elements in a field emission display device.

Another object of the present invention is to provide a novel field emission display device provided with a protection structure having at least one reduction plate or electrode for altering the discharge path of ionized gases and preventing the gases from inducing an electrical surge which may otherwise cause burnout damage to field emission elements in the device.

Still another object of the present invention is to provide a novel field emission display device having a protection structure which may include multiple reduction plates or electrodes interspersed among field emission elements on a cathode in the device to alter the discharge path of ionized gases in the device and prevent current-induced burnout damage to the field emission elements.

A still further object of the present invention is to provide a novel field emission display device which includes a protection structure that substantially prolongs the lifetime of field emission elements in the device.

Another object of the present invention is to provide a novel field emission display device having a protection structure which may include multiple, elongated reduction plates or electrodes that run parallel to and between rows of field emission elements in the device.

Yet another object of the present invention is to provide a novel field emission display device having a protection structure that is arranged in a meshwork- or net-shaped configuration among field emission elements in the device.

In accordance with these and other objects and advantages, the present invention is generally directed to a novel protection structure for protecting field emission elements in a field emission display device from burnout damage due to electrical current surges induced to the device cathode by ionized gases in the device.

The structure includes one or multiple reduction plates or electrodes which are typically provided on the cathode. A voltage source is electrically connected to the reduction plate or plates to alter the discharge path of the ionized gases from the device cathode to the reduction plate or plates. Consequently, induction of electrical current surges to the cathode is avoided, thereby preventing burnout damage to the field emission elements.

In a typical embodiment of the invention, multiple reduction plates or electrodes are interspersed among the field emission elements in the device. In one embodiment, the multiple reduction plates or electrodes are elongated and run parallel and adjacent to rows of field emission elements in the device. In another embodiment, the multiple reduction plates or electrodes are arranged in a meshwork- or net-shaped configuration among the field emission elements in the device.

### BRIEF DESCRIPTION OF THE DRAWINGS

FIG. 1A is an enlarged, cross-sectional view of a cathode and field emission element structure of a conventional field emission display device;

FIG. 1B is a cross-sectional view of a complete conventional field emission display device structure;

FIG. 1C is a cross-sectional view of a conventional field emission display device, illustrating electron bombardment of a conductive layer on the anode of the device;

FIG. 2A is a schematic of a conventional field emission display device, illustrating ionization of oxygen and nitrogen gas in the device by high-energy electrons emitted by the field emission elements;

FIG. 2B is a schematic of the conventional field emission display device, as shown in FIG. 2A, illustrating discharge of oxygen and nitrogen ions to the cathode of the device;

FIG. 3 is a schematic of a field emission display device of the present invention, illustrating discharge of positive oxygen and nitrogen ions to a negatively-charged reduction plate or electrode;

FIG. 4 is a perspective, partially schematic, view of one embodiment of the field emission display device of the present invention, illustrating elongated reduction plates or electrodes arranged parallel and adjacent to rows of field emission elements of the device; and

FIG. 5 is a perspective, partially schematic, view of another embodiment of the field emission display device of the present invention, illustrating reduction plates or electrodes arranged in a meshwork- or net-shaped pattern among the field emission elements of the device.

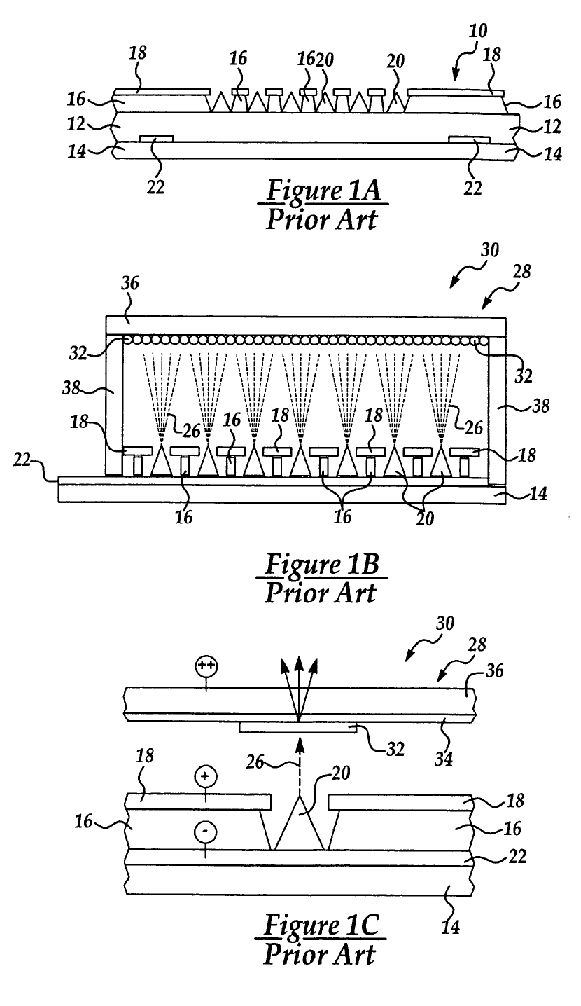

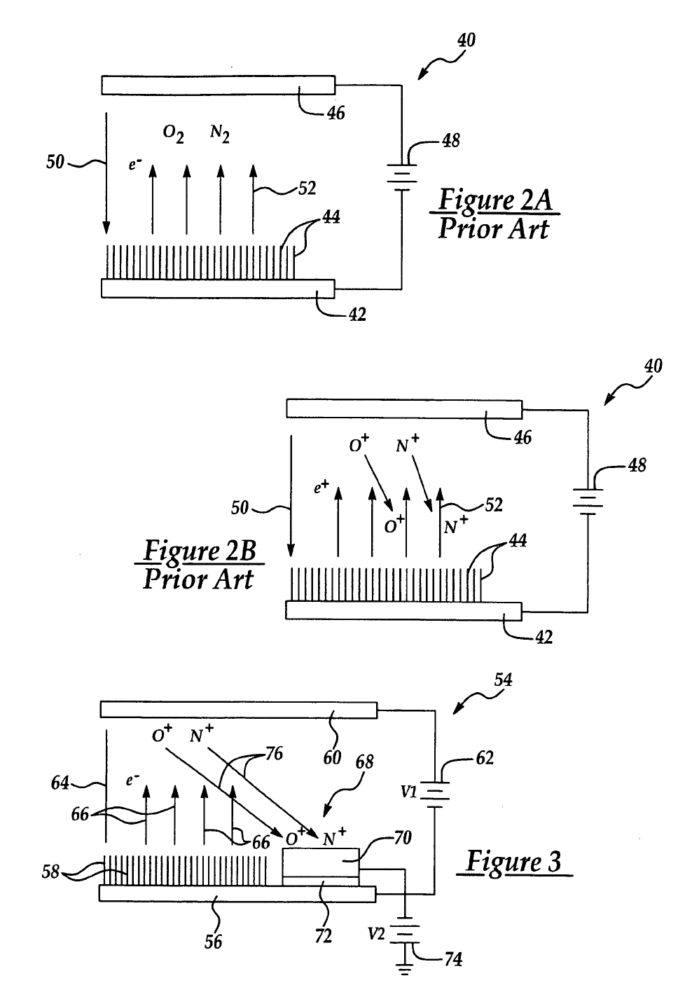

### DETAILED DESCRIPTION OF THE INVENTION

The present invention is directed to a field emission display device which includes a structure for deflecting the discharge path of gas ions away from a cathode. This prevents surges in electrical current from being drawn to the cathode and inducing burnout damage to field emission elements provided in electrical communication with the cathode. Consequently, the lifetime of the device is substantially prolonged.

Referring initially to FIG. 3, wherein a schematic of a field emission device 54 according to the present invention is shown. The field emission device 54 includes a cathode 56 provided in electrical communication with multiple field emission elements 58. Each of the field emission elements 58 may be any type of dischargeable tip suitable for emitting high-energy electrons, such as carbon nanotubes, for example. An anode 60 is disposed in spaced-apart relationship to the cathode 56 and the field emission elements 58. The cathode 56 and the anode 60 may be any electrically-conducting metal. An operating voltage source 62 is electrically connected to the cathode 56 and the anode 60 to establish an electric field 64 there between.

In accordance with the present invention, a protection structure 68 includes at least one reduction plate or electrode 70 which is provided in the field emission device 54, typically on the cathode 56. The reduction plate 70 is preferably any electrically-conductive metal. An insulation layer 72, which is an electrically-insulating material, typically separates the reduction plate 70 from the cathode 56. A bias voltage source 74 is electrically connected to the reduction plate 70 for applying a negative voltage thereto, as hereinafter further described.

In operation of the FED device 54, the operating voltage source 62 applies an operating voltage potential of typically about 1000V between the cathode 56 and the anode 60, to establish the electric field 64. Simultaneously, the bias voltage source 74 applies a negative bias voltage of typically about −1 to −30 V to the reduction plate 70. High-energy electrons 66 are emitted from the field emission elements 58 and strike a phosphors target (not shown) provided on the anode 60, to emit light from the target. These high-energy electrons 66, in transit from the field emission elements 58 to the target, strike molecular nitrogen and oxygen in the device 54, thereby ejecting electrons from the nitrogen and oxygen and forming N⁺ and O⁺ ions.

Due to the negative charge of the reduction plate 70, applied by the bias voltage source 74, the N⁺ and O⁺ ions are deflected away from the cathode 56, along a gas discharge path 76, to the reduction plate 70. Accordingly, the N⁺ and O⁺ ions are prevented from contacting the cathode 56, thereby preventing ion-induced surges in electrical current to the cathode 56 which would otherwise tend to damage the field emission elements 58. At the reduction plate 70, the N⁺ and O⁺ ions are reduced back to molecular nitrogen and oxygen as follows:
N₂⁺+e⁻→N₂
O₂⁺+e−→O₂

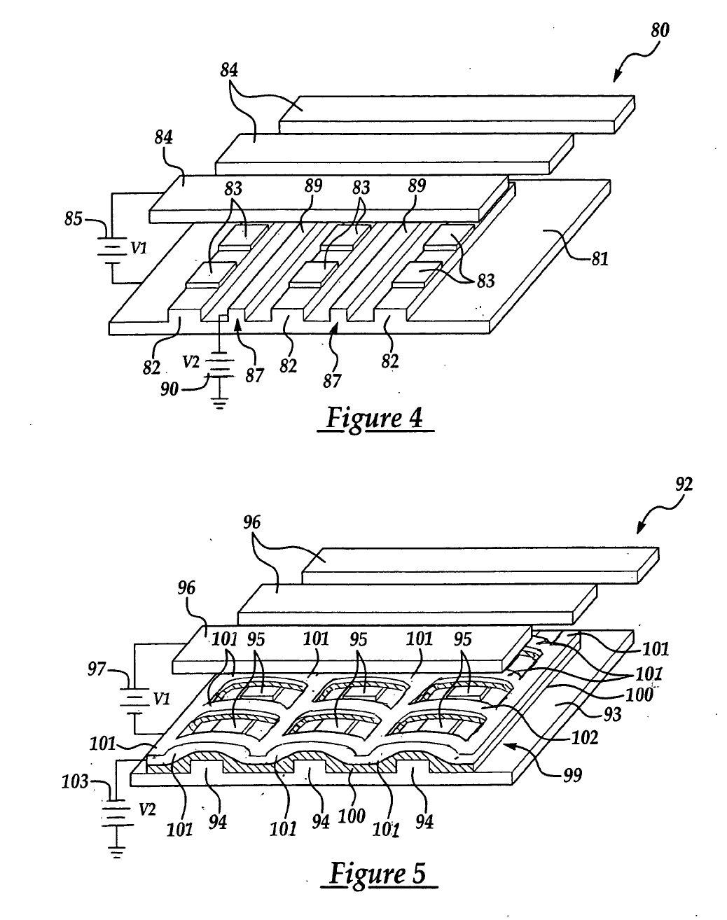

A first exemplary structure of FED device according to the present invention is illustrated in FIG. 4. As shown in FIG. 4, a FED device 80 includes a cathode plate 81 having a plurality of elongated, parallel cathode strips 82 thereon, anodes 84 spaced-apart from the cathode plate 81, and an operating voltage source 85 electrically connected to the cathode strips 82 and anodes 84. Multiple, spaced-apart field emission elements 83 are provided on each of the cathode strips 82. Each of the field emission elements 83 may be any type of dischargeable tip suitable for emitting high-energy electrons, such as carbon nanotubes, for example.

A protection structure 87 of the FED device 80 includes multiple, elongated reduction plates or electrodes 89 that are provided on the cathode plate 81. The reduction plates 89 extend parallel and adjacent to the cathode strips 82 on which the field emission elements 83 are provided. A bias voltage source 90 is electrically connected to each reduction plate 89 of the protection structure 87 for applying a negative bias voltage to the reduction plate 89. Accordingly, the negative bias voltage applied by the bias voltage source 90 imparts a negative charge to the reduction plates 89 which attracts positive nitrogen and oxygen ions thereto and prevents current-induced damage to the field emission elements 83, as heretofore described with respect to the protection structure 68 of FIG. 3.

The reduction plates 89 may be fabricated on the cathode plate 81 at the same as the cathode strips 82. In manufacture, a metal material, i.e., the metal cathode plate 81, is first deposited on a substrate (not shown), using conventional deposition techniques. Photolithography techniques are then used to form a first mask (not shown) which defines the location and geometry of the cathode strips 82 and the reduction plates 89 on the cathode plate 81. The cathode plate 81 is then etched to form the cathode strips 82 and the reduction plates 89 according to the pattern defined by the first mask. A wet etching method may be used to precisely control the geometry and size of the cathode strips 82. Next, a second mask (not shown) is formed on the cathode strips 82 and the reduction plates 89 to define the geometry and location of the field emission elements 83 on the cathode strips 82, followed by etching and fabrication of the field emission elements 83. In this structure, the reduction plates 89 and the cathode strips are formed on a same plane and are parallel and alternately spaced-apart. Each of the reduction plate 80 provides protection for its adjacent field emission elements 83.

In addition to the elongated and parallel structure described above, the reduction plates 89 can also be formed in a meshwork-shape or a net-shape according to another exemplary embodiment of the present invention, which is shown in FIG. 5. As shown in FIG. 5, an FED device 92 includes a cathode plate 93; multiple, elongated, parallel cathode strips 94 fabricated on the cathode plate 93; anodes 96 disposed in spaced-apart relationship to the cathode plate 93; and an operating voltage source 97 electrically connected to the cathode strip 94 and anodes 96. Multiple field emission elements 95 are provided on each of the cathode strips 94 for emitting high-energy electrons toward the anode 96.

A meshwork-shaped or net-shaped protection structure 99 including reduction plates 101 is provided on the cathode plate 93 of the FED device. The reduction plates 101 are formed on the top of the cathode plate 93 and is separated from the cathode strips 94 by an insulation layer 100. Accordingly, the reduction plates 101 along with the underlying insulation layer 100 impart a meshwork- or net-shaped configuration to the protection structure 99.

A bias voltage source 103 is electrically connected to the reduction plates 101 of the protection structure 99. The bias voltage source 103 applies a negative voltage to the protection structure 99 to attract positive nitrogen and oxygen ions formed by the high-energy electrons emitted by the field emission elements 95. This prevents the ions from contacting the cathode strips 94 and inducing surging of an excessive electrical current to the cathode strips 94 and field emission elements 95, as heretofore described with respect to the FED device 54 of FIG. 3.

The manufacturing of the FED device 92 is described below. Initially, a first metal layer is deposited on a substrate (not shown) to form the cathode plate 93. A first mask (not shown) is then patterned on the cathode plate 93 to etch the cathode strips 94 therein. After the first mask is removed from the cathode plate 93, the insulator layer 100 is deposited over the cathode plate 93 and cathode strips 94. Next, a second metal layer for the reduction plates 101 is deposited on the insulator layer 100, followed by formation of a second mask (not shown) using a negative photoresist to define the geometry and location of the light emission elements 95. The second metal layer is then etched away the region for forming the field emission elements 95, leaving the reduction plates 101. Afterward, keeping the second mask unremoved, the regions where the second metal layer is removed are then deposited with materials for the light emission elements 95. After the light emission elements 95 are formed, the structure of the FED device 92 as shown in FIG. 5 is completed.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A field emission display device, comprising:
a cathode;
an anode disposed in spaced-apart relationship with respect to said cathode;
a plurality of field emission elements between said cathode and said anode for emitting electrons; and
a protection structure between said cathode and said anode for attracting positive ions.

2. The device of claim 1, wherein the cathode comprises a plurality of parallel cathode strips.

3. The device of claim 2, wherein said protection structure comprises at least one reduction plate and a bias voltage source electrically connected to said at least one reduction plate for applying a negative voltage to said at least one reduction plate.

4. The device of claim 3, wherein said at least one reduction plate comprises a plurality of elongated reduction plates disposed in generally parallel relationship to each other.

5. The device of claim 4, wherein said plurality of elongated reduction plates are formed on a same plane as the plurality of cathode strips and are parallelly alternately adjacent to the plurality of cathode strips.

6. The device of claim 1, wherein said protection structure comprises a plurality of reduction plates in a form of a meshwork shape or a net shape.

7. The device of claim 6, wherein the plurality of the reduction plates are formed on the top of the cathode.

8. The device of claim 7, further comprising an insulation layer between the reduction plates and the cathode.

9. The device of claim 7, wherein the plurality of the reduction plates surrounds the light emission elements.

10. The device of claim 1, wherein said plurality of field emission elements comprises a plurality of carbon nanotubes.

11. The device of claim 3, wherein said field emission elements are disposed in multiple rows and said at least one reduction plate is disposed generally parallel to said multiple rows of said field emission elements.

12. A field emission display device, comprising:
a cathode plate having a plurality of elongated cathode strips;
an anode disposed in spaced-apart relationship with respect to said cathode plate;
a plurality of field emission elements provided on each of said cathode strips for emitting electrons; and
a protection structure provided on said cathode plate for attracting positive ions.

13. The device of claim 12, wherein said protection structure comprises a plurality of elongated reduction plates that is disposed generally parallel to said cathode strips and is alternately adjacent to said cathode strips and a bias voltage source electrically connected to said reduction plates.

14. The device of claim 12 wherein said plurality of field emission elements comprises a plurality of carbon nanotubes.

15. A method of fabricating a protection structure for a field emission display device, comprising the steps of:
providing a cathode plate; and
fabricating a plurality of cathode strips and at least one reduction plate on said cathode plate.

16. The method of claim 15 wherein said fabricating of a plurality of cathode strips and at least one reduction plate on said cathode plate comprises:
depositing a metal layer on the top of a substrate;
applying a first photoresist on the metal layer, the first photoresist defining patterns of the plurality of cathode strips and a plurality of the reduction plates; and
etching the resist to form said plurality of cathode strips and said plurality of the reduction plate in said cathode plate.

17. The method of claim 16, wherein said plurality of cathode strips and said plurality of the reduction plates are parallel with each other and are alternately adjacent to each other.

18. The method of claim 16, further comprising forming a plurality of light emission elements on the plurality of cathode strips.

19. The method of claim 15 wherein said fabricating of the plurality of cathode strips and the at least one reduction plate comprises:
depositing a first metal layer on a substrate;
etching the first metal layer by means of a first photoresist to form the plurality of cathode strips;
depositing an insulation layer on an entire surface after the plurality of cathode strips is formed;
depositing a second metal layer on the top of the insulation layer, the second metal layer is used for forming said at least on reduction plate; and
etching the second metal layer by means of a second photoresist to etch away regions for forming light emission elements, leaving said at least one reduction plate surrounding the regions for forming the light emission elements.

20. The method of claim 19, wherein the second photoresist is a negative photoresist.

21. The method of claim 19, wherein the at least one reduction plate is a meshwork or net shape.
